(19) United States
(12) Patent Application Publication
(10) Pub. No.: US 2026/0349710 A1
(43) Pub. Date: Nov. 5, 2026

(54) PROGRAM CODE EVALUATION SYSTEM AND METHOD FOR EXAMINING UNIQUENESS OF COMPUTER PROGRAM CODE SUBMISSIONS

(71) Applicant: Automation Anywhere, Inc., San Jose, CA (US)

(72) Inventor: Aaron Gleason, Wylie, TX (US)

(73) Assignee: Automation Anywhere, Inc., San Jose, CA (US)

(21) Appl. No.: 19/194,857

(22) Filed: Apr. 30, 2025

(51) Int. Cl. G06F 8/71

(52) U.S. Cl. CPC G06F 8/71

(57) ABSTRACT

Improved techniques and systems for evaluating computer program code submissions for uniqueness. One embodiment can electronically receive a computer program code submission, and intelligently generate a fingerprint for the computer program code submission. Then, the generated fingerprint can be compared with previously-submitted fingerprints for one or more previously-submitted computer program code submissions to produce comparison data. The comparison data can be used to determine whether the computer program code submission is a unique (e.g., non-duplicate) computer program code submission. Thereafter, the computer program code submission can be accepted or declined. One embodiment can, additionally or alternatively, involve extracting comments from the computer program code submission, comparing the extracted comments with previously-submitted comments within previously-submitted computer program code submissions, and determining a comment similarity score for the extracted comments associated with the computer program code submission.

### BACKGROUND OF THE INVENTION

Today, online training and certifications are used to gain proficiency with software products. Often, such training or certification requires users to build and submit computer programs as part of the requirements to obtain certification. Technology companies commonly rely on certification processes to ensure employees and customers can effectively use their products.

Unfortunately, however, those seeking training or certification may be looking for short cuts to complete the training or certification with minimal effort. There are also many websites that offer guidance on passing such training or certifications without the requisite knowledge. When short cuts are used, it results in potentially unqualified users obtaining certifications. As a result, when others rely on the certifications, such as for hiring employees, they can be misled and such can cause businesses to lose time and money.

Traditionally, human evaluators have manually reviewed computer program submissions for training or certifications. However, this human effort is time-consuming and prone to error, but also does not allow for immediate, large-scale analysis of program submissions with high accuracy and speed. Online training and certifications are able to provide immediate and large-scale analysis, but are vulnerable to users using short cuts.

Therefore, there is a need for improved approaches to efficiently and accurately evaluate computer program code submissions seeking certifications and the like while also mitigating against fraudulent efforts to acquire certifications.

### SUMMARY

Improved techniques and systems for evaluating computer program code submissions for uniqueness are disclosed. One embodiment can electronically receive a computer program code submission, and intelligently generate a fingerprint for the computer program code submission. Then, the generated fingerprint can be compared with previously-submitted fingerprints for one or more previously-submitted computer program code submissions to produce comparison data. The comparison data can be used to determine whether the computer program code submission is a unique (e.g., non-duplicate) computer program code submission. Thereafter, the computer program code submission can be accepted or declined based on whether the computer program code submission is determined to be a unique computer program code submission. One embodiment can, additionally or alternatively, involve extracting comments from the computer program code submission, comparing the extracted comments with previously-submitted comments within previously-submitted computer program code submissions, and determining a comment similarity score for the extracted comments associated with the computer program code submission based on results of the comparing.

The invention can be implemented in numerous ways, including as a method, system, device, or apparatus (including computer readable medium and graphical user interface). Several embodiments of the invention are discussed below.

As a computer-implemented method for detecting duplicate computer program code submissions, one embodiment can, for example, include at least: receiving a program code submission, the program code submission identifying or providing a computer program code file; generating a fingerprint for the computer program code file; comparing the generated fingerprint with previously-submitted fingerprints for a plurality of previously-submitted computer program code files to produce comparison data; determining whether the computer program code file is considered a duplicate computer program based on the comparison data; and rejecting the program code submission when the determining determines that the computer program code file is considered a duplicate computer program.

As a computer-implemented method for detecting duplicate computer program code submissions, one embodiment can, for example, include at least: receiving, at a bot evaluation server, a bot submission for grading, the bot submission identifying or providing a bot within a bot file; generating a digital fingerprint for the bot; comparing the generated digital fingerprint with previously-submitted digital fingerprints for a plurality of previously-submitted bots to the bot evaluation server, the comparing producing fingerprint comparison data; extracting comments from the bot; comparing the extracted comments with previously-submitted comments within the plurality of previously-submitted bots to the bot evaluation server, the comparing producing comment comparison data; determining whether the bot is considered a duplicate bot based on the fingerprint comparison data and the comment comparison data; and grading the bot identified or provided with the bot submission, within the grading is unfavorable when the determining determines that the bot is considered a duplicate bot.

As a bot evaluation system for grading a bot suitable for use in a robotic process automation environment, one embodiment of the bot evaluation system can, for example, include at least: a bot submission module configured to receive a bot submission for evaluation, the bot submission identifying or providing a bot; a fingerprint generation module configured to generate a digital fingerprint for a plurality of bots, the plurality of bots including the bot and a plurality of previously-submitted bots; a database configured to store at least digital fingerprints for the plurality of previously-submitted bots; and a fingerprint comparison module configured to compare the generated digital fingerprint for the bot with one or more of the digital fingerprints stored in the database for the plurality of previously-submitted bots. The bot evaluation system can also include a comment similarity module configured to compare one or more comments that are included with the bot submission with previously submitted comments contained within the plurality of previously-submitted bots.

As a non-transitory computer readable medium including at least computer program code tangible stored therein for detecting computer program code submissions that are non-unique, one embodiment of the invention can, for example, include at least: computer program code for receiving a program code submission, the program code submission identifying or providing a computer program code file; computer program code for generating a fingerprint for the computer program code file; computer program code for comparing the generated fingerprint with previously-submitted fingerprints for a plurality of previously-submitted computer program code files to produce comparison data; computer program code for determining whether the computer program code file is considered a unique computer program based on the comparison data; and computer program code for declining the program code submission when the determining determines that the computer program code file is not considered a unique computer program.

As a non-transitory computer readable medium including at least computer program code tangible stored therein for detecting computer program code submissions that are non-unique, one embodiment of the invention can, for example, include at least: computer program code for receiving a program code submission, the program code submission identifying or providing a computer program code file; computer program code for generating a fingerprint for the computer program code file; computer program code for comparing the generated fingerprint with previously-submitted fingerprints for a plurality of previously-submitted computer program code files to produce fingerprint comparison data; computer program code for extracting comments from the computer program code file; computer program code for comparing the extracted comments with previously-submitted comments within the plurality of previously-submitted computer program code files to produce comment comparison data; and computer program code for determining whether the computer program code file is considered a unique computer program based on the fingerprint comparison data and the comment comparison data. The non-transitory computer readable medium can also include computer program code for declining the program code submission when the determining determines that the computer program code file is not considered a unique computer program.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a system diagram of a program code evaluation system according to one embodiment.

FIG. 2 is a block diagram of a program code evaluation server according to one embodiment.

FIG. 3 is a flow diagram of a program code evaluation process according to one embodiment.

FIG. 4 is a flow diagram of a fingerprint process according to one embodiment of the invention.

FIG. 5 is a flow diagram of a comment evaluation process according to one embodiment.

FIG. 6 is an exemplary graphical user interface for requesting certification grading according to one embodiment.

FIG. 7A is an exemplary graphical user interface for presenting grading results from a first request for certification grading according to one embodiment.

FIG. 7B is an exemplary graphical user interface for presenting grading results from a second request for certification grading according to one embodiment.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of the bot compiler illustrated in FIG. 10.

FIG. 12 is a block diagram of an exemplary computing environment for an implementation of a robotic process automation system.

### DETAILED DESCRIPTION OF CERTAIN EMBODIMENTS

Improved techniques and systems for evaluating computer program code submissions for uniqueness are disclosed. One embodiment can electronically receive a computer program code submission, and intelligently generate a fingerprint for the computer program code submission. Then, the generated fingerprint can be compared with previously-submitted fingerprints for one or more previously-submitted computer program code submissions to produce comparison data. The comparison data can be used to determine whether the computer program code submission is a unique (e.g., non-duplicate) computer program code submission. Thereafter, the computer program code submission can be accepted or declined based on whether the computer program code submission is determined to be a unique computer program code submission. One embodiment can, additionally or alternatively, involve extracting comments from the computer program code submission, comparing the extracted comments with previously-submitted comments within previously-submitted computer program code submissions, and determining a comment similarity score for the extracted comments associated with the computer program code submission based on results of the comparing.

In one embodiment, a fingerprint generated for a computer program code submission can focus on functional lines of code, excluding non-functional elements such as comments, pop-up windows, logging, and delays. In one implementation, the fingerprint can be derived from the sequence of functions used within the computer program code, and can ignore the parameters passed to those functions. By analyzing the order of functions, the method can generate a distinctive fingerprint in the form of a character string. This fingerprint is then stored in a database and compared against other stored fingerprints to identify any duplicate submissions.

The Improved techniques and systems described herein are applicable to certification processes, coding challenges, and any scenario where computer program code submissions are required. The Improved techniques and systems can be used to ensure the authenticity of submissions and prevent the unauthorized duplication of code, and can do so in near real-time, even at large-scale, with high accuracy and speed.

In one embodiment, the program code submissions can pertain to software automation processes (e.g., software robots, bots) that have been created and then submitted for evaluation, such as certification or grading.

Robotic Process Automation (RPA) systems enable automation of repetitive and manually intensive computer-based tasks. In an RPA system, computer software, namely a software robot (often referred to as a “bot”), may mimic the actions of a human to perform various computer-based tasks. For instance, an RPA system can be used to interact with one or more software applications through user interfaces, as a human would do. RPA systems typically do not need to be integrated with existing software applications at a programming level, thereby eliminating the difficulties inherent to integration. Advantageously, RPA systems permit the automation of application level repetitive tasks via software robots that are coded to repeatedly and accurately perform the repetitive task.

Generally speaking, RPA systems use computer software to emulate and integrate the actions of a human interacting within digital systems. In an enterprise environment, the RPA systems are often designed to execute a business process. In some cases, the RPA systems use artificial intelligence (AI) and/or other machine learning capabilities to handle high-volume, repeatable tasks that previously required humans to perform. The RPA systems also provide for creation, configuration, management, execution, and/or monitoring of software automation processes.

A software automation process can also be referred to as a software robot, software agent, automation program or bot. A software automation process can interpret and execute tasks on one's behalf. In doing so, sometimes the software automation process operates to access one or more remote resources via a network. In one embodiment, the remote resource are network accessible resources. The network accessible resources are, for example, an authentication server, a web server, a remote database, or a cloud-based storage.

Software automation processes are particularly well suited for handling a lot of the repetitive tasks that humans perform every day. Software automation processes can accurately perform a task or workflow they are tasked with over and over. As one example, a software automation process can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation process can perform data tasks, such as reformatting, extracting, balancing, error checking, moving, copying, or any other desired tasks. As another example, a software automation process can grab data desired from a webpage, application, screen, file, or other data source. As still another example, a software automation process can be triggered based on time or an event, and can serve to take files or data sets and move them to another location, whether it is to a customer, vendor, application, department or storage. These various capabilities can also be used in any combination. As an example of an integrated software automation process making use of various capabilities, the software automation process could start a task or workflow based on a trigger, such as a file being uploaded to an FTP system. The integrated software automation process could then download that file, scrape relevant data from it, upload the relevant data to a database, and then send an email to a recipient to inform the recipient that the data has been successfully processed.

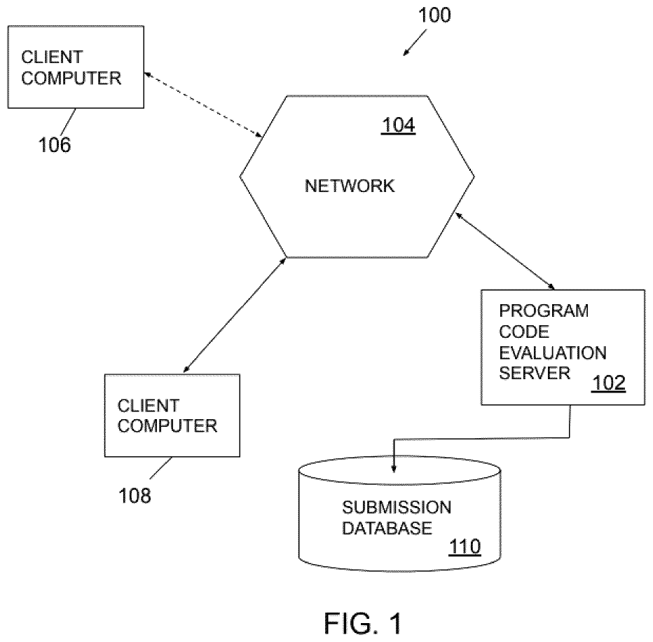

Embodiments of various aspects of the invention are discussed below with reference to FIGS. 1-12. However, those skilled in the art will readily appreciate that the detailed description given herein with respect to these figures is for explanatory purposes as the invention extends beyond these limited embodiments.

FIG. 1 is a system diagram of a program code evaluation system 100 according to one embodiment. The program code evaluation system 100 is configured to receive and review on-line submissions of program code for satisfying various criteria.

The program code evaluation system 100 includes a program code evaluation server 102. The program code evaluation server 102 receives and evaluates program code submissions from one or more client devices. In this regard, the program code evaluation server 102 is coupled to a network 104. The network 104 can include one or more networks, which can be wired or wireless. The evaluation(s) performed on program code submissions serves to evaluate program code that is provided with the respective program code submissions. The particular evaluation(s) performed can vary with embodiment, but can include one or more of duplicate code checking, comment comparison, comment quality checking, required commends checking, syntax validation, etc., as examples.

In addition, the program code evaluation system 100 can support one or more client computers 106, 108 to interact with the program code evaluation server 102 via the network 104. The client computer 106 is, for example, communicating with the network 104 via a wireless link. The client computer 108 is communicating with the network 104 via a wired link. The one or more client computers 106, 108 can, for example, be desktops, laptops, tablets, smart phones, and other personal computing devices. For example, a user can use the one or more client computers 106, 108 to submit a program code submission to the program code evaluation server 102 via the network 104.

The program code evaluation system 100 can also include a submission database 110. The submission database 110 can store data pertaining to at least prior submissions that have been submitted to the program code evaluation server 102. More particularly, the program code evaluation server 102 can store to the submission database 110 submission data pertaining to prior program code submissions that have been evaluated by the program code evaluation server 102. These stored prior submission data can be subsequently used by the program code evaluation server 102 when evaluating a current program code submission in relation to prior program code submissions, such as for uniqueness, duplication, completeness, and the like. The submission data can also include data that can be used to reference the submitter, such as personal identifying information (GUID, email, username, etc.). The program code evaluation server 102 can thus take into consideration whether a current program code submission is from the same submitted as prior program code submissions, so as to possibly permit non-uniqueness or duplication if from the same submitter.

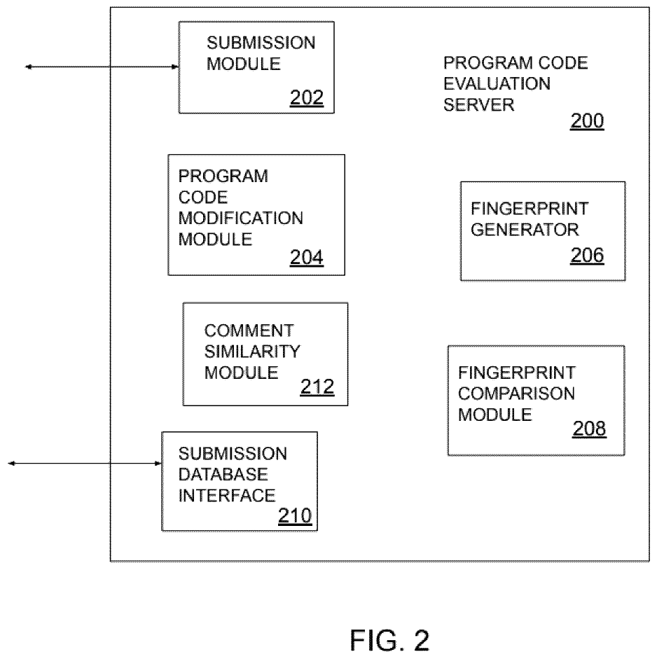

FIG. 2 is a block diagram of a program code evaluation server 200 according to one embodiment. The program code evaluation server 200 can, for example, pertain to one embodiment of the program code evaluation server 102 illustrated in FIG. 1.

The program code evaluation server 200 illustrated in FIG. 2 can include a submission module 202 that is configured to receive program code submissions via the network 104 from one or more client computers, such as the client computer 106 or the client computer 108 illustrated in FIG. 1.

The program code evaluation server 200 can also include a program code modification module 204, a fingerprint generator 206 and a fingerprint comparison module 208. The fingerprint generator 206 is configured to produce an electronic fingerprint that represents program code that has been submitted with a program code submission. The program code modification module 204 is configured to modify program code that has been submitted with a program code submission such that it is better suited for use in generating a fingerprint. For example, modifications to the program code can remove non-functional components from the program code so that the modified program code is focused on functional components. The fingerprint generator 206 can produce an electronic fingerprint for the modified program code that results from the program code modification module 204.

After a fingerprint has been generated for program code that has been submitted for the program code submission (which is, for example, after being suitably modified by the program code modification module 204), the generated fingerprint can be compared with prior stored fingerprints by the fingerprint comparison module 208. Here, the prior fingerprints pertaining to previously submitted program code submissions can, for example, be stored in the submission database 110 and accessed by the program code evaluation server 200, such that the fingerprint comparison module 208 can compare the prior fingerprints with the currently generated fingerprint. Based on the comparisons provided by the fingerprint comparison module 208, the program code evaluation server 200 can determine whether the current program code submission is sufficiently unique from prior program code submissions.

The program code evaluation server 200 can also include a submission database interface 210. The submission database interface 210 can be configured to facilitate access by the program code evaluation server 200 to a submission database, such as the submission database 110 illustrated in FIG. 1.

Furthermore, the program code evaluation server 200 can, in some embodiments, also include a comment similarity module 212. The comment similarity module 212 can operates to compare comments that are included within a computer program code submission. The comparing of comments can, for example, compare the comments within a current computer program code submission with previously submitted comments contained with previously submitted computer program code submissions. The previously submitted comments can, for example, be stored in the submission database, such as the submission database 110 illustrated in FIG. 1.

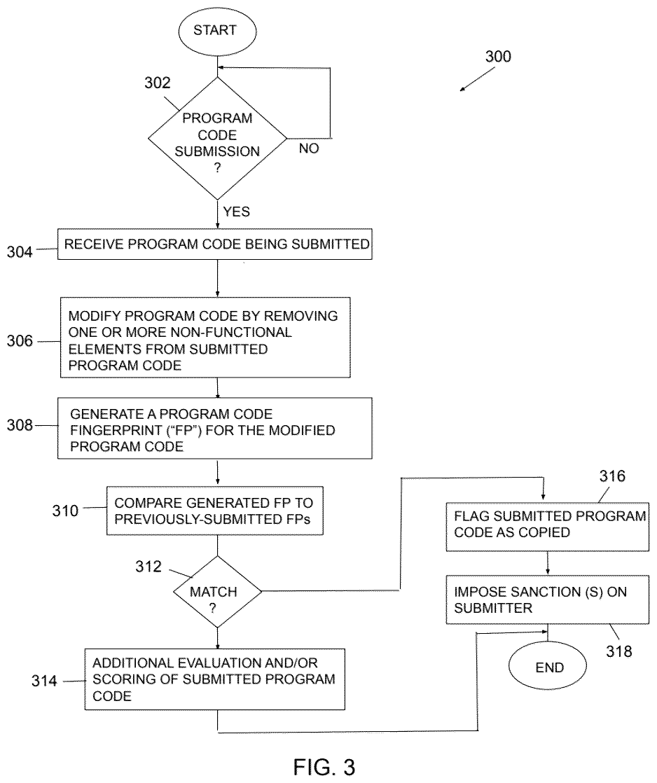

FIG. 3 is a flow diagram of a program code evaluation process 300 according to one embodiment. The program code evaluation process 300 is, for example, processing carried out by a program code evaluation server, such as the program code evaluation server 102 illustrated in FIG. 1 or the program code evaluation server 200 illustrated in FIG. 2, as examples.

The program code evaluation process 300 can include a decision 302 that determines whether a program code submission has been received. When the decision 302 determines that a program code submission has not yet been received, the program code evaluation process 300 can await receipt of such a submission.

On the other hand, when the decision 302 determines that a program code submission has been received, the program code evaluation process 300 can then continue its processing. In this regard, when the program code evaluation process 300 continues, the program code evaluation process 300 can receive 304 program code being submitted by the program code submission that has been received. Next, the program code that has been submitted can be modified 306. In one embodiment, the submitted program code can be modified 306 to produce modified program code by removing one or more non-functional elements from the submitted program code. [For example, non-functional elements, such as comments, can be removed.

Thereafter, a program code fingerprint can be generated 308 for the modified program code. Here, the program code fingerprint can be computer generated using an algorithm, such as a string-based command identifiers algorithm or Hashing algorithm. By removing one or more non-functional elements from the submitted program code before the program code fingerprint is produced, the resulting electronic fingerprint is targeted to functional elements within the submitted program code. As a result, the resulting electronic fingerprints are better suited for comparison operations that are targeted to identify non-unique program code.

The generated fingerprint can then be compared 310 to previously-submitted fingerprints. The previously submitted-fingerprints are, for example, stored in a submission database, such as the submission database 110 illustrated in FIG. 1. Following the comparing 310 of fingerprints, a decision 312 can determine whether a match has been found. A match can be deemed found if the generated fingerprint matches one of the previously-submitted fingerprints. Also, the program code fingerprint that has been generated 308, i.e., generated fingerprint, can be stored to the submission database.

When the decision 312 determines that a match has not been found, additional evaluation and/or scoring of the submitted program code can be performed 314. Here, for example, the additional evaluation and/or scoring can include one or more of: similarity comparison of comments, programming rules compliance, etc.

On the other hand, when the decision 312 determines that a match has been found, the submitted program code can be flagged 316 as non-unique (e.g., substantially similar to be deemed a copy or duplicate) of previously submitted program code. For example, given that a match was found between the generated fingerprint and at least one of the previously-submitted fingerprints, the submitted program code of the program code submission is deemed to be a copy or duplicate submission. Given the processing and use of fingerprints, the submitted program code only need be substantially the same as program code from prior program code submissions. Also, in the case where a match has been found, the program code evaluation process 300 can also impose 316 one or more sanctions on the submitter. Examples of sanctions can include, denying certification, denying further submissions for a least a period of time, etc. Following the block 314 or the block 318, the program code evaluation process 300 can end.

In one embodiment, additional sanction could be imposed on others that might has facilitated the submitter submission of a copy or duplicate submission. This could involve a sanction on a provider of involved program code. Such a sanction could be banning the provider or revoking a certification of the provider. The generated fingerprints can be associated with submitter identifiers so the system can locate the prior submitted of the involved program code.

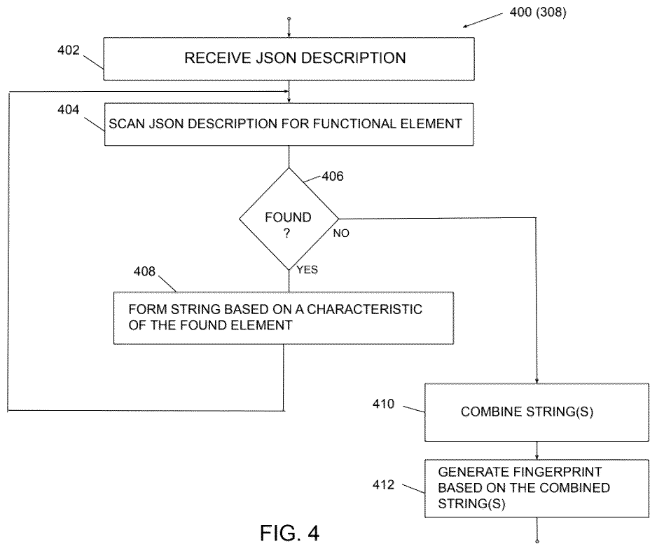

FIG. 4 is a flow diagram of a fingerprint process 400 according to one embodiment of the invention. The fingerprint process 400 is, for example, processing performed at block 308 of the program code evaluation process 300 illustrated in FIG. 3.

The fingerprint process 400 receives a description, such as a JSON description, of the submitted program code. The JSON description can then be scanned 404 for a functional element. Examples of functional elements are commands, packages, function calls, external system calls, and child processes. A decision 406 can then determine whether a functional element has been found. When the decision 406 determines that a functional element has been found within the JSON description, a string can be formed 408 based on one or more characteristics of the found functional element. For example, the one or more characteristics being used to form 408 the string for the determined functional element can include at least a portion of: function name, package name, or the like. Following the forming 408 of the string for the found functional element, the fingerprint process can return to repeat the block 404 and subsequent blocks so that additional functional element(s) within the JSON description for the submitted program code can be similarly processed.

Alternatively, when the decision 406 determines that there are no functional elements (or no more additional functional elements) that have been found within the JSON description, the fingerprint process 400 can combine 410 the one or strings that have been formed for the one or more found functional elements. Then, a fingerprint can be generated 412 based on the combined strings. After the fingerprint has been generated 412 for the JSON description of the submitted program code, the fingerprint process 400 can conclude its processing using the fingerprint for the JSON description of the submitted program code being generated.

As noted above, a fingerprint can be generated for submitted computer program code. Below is an embodiment of exemplary program code to generate a fingerprint for a program code submission. In the exemplary computer program code, comments (denoted by a preceding “//”) are included for assisting with understanding. The embodiment of the exemplary program code for fingerprint generation is as follows:

```
//receive application in JSON format
VAR node = REST Web Services: POST
//variable to hold fingerprint
VAR fingerprint = “”
//loop through each program node
FOR EACH node AS line
    //ignore lines with non-functional elements
    IF line STARTS WITH (“//”, “/*”, “REM”, “COMMENT”,
“STEP”, “#”, “MSGBOX”, “DELAY”, “SLEEP”, “WAIT”)
GOTO NEXT
    //get first two characters of the program command
    fingerprint += line[:2]
//finish looping through the node
END FOR
```

After a fingerprint has been generated for submitted computer program code, the fingerprint can be used to evaluate whether the submitted computer program code is considered non-unique (e.g., substantially a copy or duplicate) of previously submitted computer program code. Below is an embodiment of exemplary program code to access a database and checking for matching fingerprints, and adding the fingerprint that has been generated to the database. In the exemplary computer program code, comments (denoted by a preceding “//”) are included for assisting with understanding. The embodiment of the exemplary program code for evaluation is as follows:

//after fingerprint has been generated, use database in
duplicate checking.
//connect to database
VAR dbconn = MYSQL_CONNECT( )
//query database for duplicate fingerprint
VAR result = dbconn.query(“SELECT
COUNT(FINGERPRINT) AS MYCOUNT, EMAIL FROM
FINGERPRINT_TABLE WHERE FINGERPRINT = ” +
fingerprint)
//check for duplicate based on count and submitter's email
IF result(“MYCOUNT”) > 0 && result(“EMAIL”) !=
tester email REPORT_CHEATER( )
//add fingerprint to database
VAR result = dbconn.query(“INSERT INTO
FINGERPRINT_TABLE (FINGERPRINT, EMAIL) VALUES
(“‘ + fingerprint + ”’, “‘ + tester_email + ”’)”)
//close database
dbconn.close( )

In one embodiment, the computer program code evaluation processing can, for example, can operates in accordance with the following processing of submitted computer program code. A first computer program code submission is considered below as a simplified (e.g., truncated) first code block (denoted “Code block 1 (truncated)”). A second computer program code submission is considered below as a simplified (e.g., truncated) second code block (denoted “Code block 2 (truncated)”). Exemplary processing of submission of the first code block and the second code block are presented below.

### A. Generation of Fingerprint for Code Block 1 (Truncated)

### 1. Code Block 1 (Truncated):

```
{
  “nodes”: [{
          “commandName”: “downloadFile”,
          “packageName”: “Browser”
        }
      ],
      “commandName”: “comment”,
      “packageName”: “Comment”
    }, {
          “commandName”: “OpenSpreadsheet”,
          “packageName”: “Excel_MS”
        }
      ],
      “commandName”: “comment”,
      “packageName”: “Comment”
    }
```

2. Removal of Non-Functional Elements from Code Block 1:

```
{
  “nodes”: [{
          “commandName”: “downloadFile”,
          “packageName”: “Browser”
        }
      ],
    }, {
          “commandName”: “OpenSpreadsheet”,
          “packageName”: “Excel_MS”
        }
      ],
    }
```

### 3. Resulting Modified Code Block 1 for Use in Generating Fingerprint:

```
{
  “nodes”: [{
          “commandName”: “downloadFile”
          “packageName”: “Browser”
        }
      ],
{
          “commandName”: “OpenSpreadsheet”,
          “packageName”: “Excel_MS”
        }
      ]
    }
```

### 4. Generation of Fingerprint for the Modified Code Block 1:

In one embodiment, a fingerprint can be generated using names contained in the code block, such as command names and/or package names. In one particular implementation, the generation of a fingerprint can be based on using the first two characters of both the commandName and the packageName, see bolded characters below:
“commandName”: “downloadFile”,
“packageName”: “Browser”
“commandName”: “OpenSpreadsheet”,
“packageName”: “Excel_MS”
   Here, for this particular implementation, the resulting fingerprint for Code block 1 is: “doBrOpEx”.

### 5. Code Block 2 (Truncated):

```
{
    “nodes”: [{
            “commandName”: “downloadFile”,
            “packageName”: “Browser”
          }
        ],
        “commandName”: “comment”,
        “packageName”: “Comment”
      }, {
        “commandName”: “comment”,
        “packageName”: “Comment”
  }, {
            “commandName”: “OpenSpreadsheet”,
            “packageName”: “Excel_MS”
          }
        ],
        “commandName”: “comment”,
        “packageName”: “Comment”
      }
```

6. Removal of Non-Functional Elements from Code Block 2:

```
{
  “nodes”: [{
          “commandName”: “downloadFile”,
          “packageName”: “Browser”
        }
      ],
    }, {
}, {
          “commandName”: “OpenSpreadsheet”,
          “packageName”: “Excel_MS”
        }
      ],
    }
```

### 7. Resulting Modified Code Block 2 for Use in Generating Fingerprint:

```
{
  “nodes”: [{
          “commandName”: “downloadFile”,
          “packageName”: “Browser”
        }
      ],
{
          “commandName”: “OpenSpreadsheet”,
          “packageName”: “Excel_MS”
        }
      ]
    }
```

### 8. Generation of Fingerprint for the Modified Code Block 2:

In one embodiment, a fingerprint can be generated using names contained in the code block, such as command names and/or package names. In one particular implementation, the same as used for the Code block 1 above, the generation of a fingerprint can be based on using the first two characters of both the commandName and the packageName, see bolded characters below:
“commandName”: “downloadFile”,
“packageName”: “Browser”
“commandName”: “OpenSpreadsheet”,
“packageName”: “Excel_MS”
   Here, for this particular implementation, the resulting fingerprint for Code block 2 is: “doBrOpEx”.

Note in this simplified (e.g., truncated) code block, the resulting fingerprint is relative simplified as well. In a more realistic code block being submitted for evaluation, there would be many more functional elements that impact the fingerprint. For example, a more realistic fingerprint would have many more characters in it fingerprint, and would be more like the following:
stStdoBrstStOpExstStiflfdeFiCrExOpExSeExSeExSeExSeExSeExSeExSeExGo ExstStloLoasNuasNuasNutoNuSeExGoEx . . . .

### B. Comparison of Fingerprints for Code Block 1 and Code Block 2

In the above processing of the Code block 1 and Code block 2, the resulting fingerprints for these code blocks were identical (i.e., both fingerprints were “doBrOpEx”). As such, the evaluation processing would consider the Code block 1 and the Code block 2 to be non-unique (i.e., substantial duplicates) because the fingerprint for Code block 1 is identical to the fingerprint for Code block 2. The respective fingerprints are identical because the functional elements of the program code in the respective code blocks are deemed identical. Note, however, the code blocks themselves as not identical but nonetheless substantially similar to be considered non-unique (e.g., substantial duplicates or copies).

In general, after a fingerprint is generated for a program code submission, the processing can check a prior submission database for an earlier submission having the same fingerprint. If a match is found, the program has identical functions, in the same order as the program fingerprint submitted earlier. In one embodiment, the database contains a submitter identifier (e.g., name, email, phone number, etc.) and date of submission. If the matching earlier submission is from the same submitter identifier, then the new submission can be considered a re-submission of a corrected program and thus a permitted submission even though having a matching fingerprint. On the other hand, if the matching earlier submission is not from the same submitter identifier, the new submission is deemed a duplicate submission from another submitter and reported as a duplicate.

In general, after a fingerprint is generated for a program code submission, the processing can check a prior submission database for an earlier submission having the same fingerprint. If a match is found, the program has identical functions, in the same order as the program fingerprint submitted earlier. In one embodiment, the database contains a submitter identifier (e.g., name, email, phone number, etc.) and date of submission. If the matching earlier submission is from the same submitter identifier, then the new submission can be considered a re-submission of a corrected program and thus a permitted submission even though having a matching fingerprint. On the other hand, if the matching earlier submission is not from the same submitter identifier, the new submission is deemed a duplicate submission from another submitter and reported as a duplicate.

Additional exemplary evaluation processing of program code submissions of a third code block and a fourth code block are presented below. In this example, the separate submission of the third code block and the fourth code block are from different submitters. Assume that the third code block is as follows (simplified by being truncated to just the commandName and packageName for the first 5 commands):
“commandName”: “Comment”, “packageName”: “Comment”
“commandName”: “assign”, “packageName”: “String”
“commandName”: “assign”, “packageName”: “String”
“commandName”: “assign”, “packageName”: “String”
“commandName”: “assign”, “packageName”: “String”
   Likewise, assume that the fourth code block is as follows (simplified by being truncated to just the commandName and packageName for the first 5 commands):
“commandName”: “Comment”, “packageName”: “Comment”
“commandName”: “Comment”, “packageName”: “Comment”
“commandName”: “Comment”, “packageName”: “Comment”
“commandName”: “messageBox”, “packageName”: “MessageBox”
“commandName”: “catch”, “packageName”: “ErrorHandler”
   The third code block after removal of non-functional elements:
“commandName”: “assign”, “packageName”: “String”
“commandName”: “assign”, “packageName”: “String”
“commandName”: “assign”, “packageName”: “String”
“commandName”: “assign”, “packageName”: “String”
   The fourth code block after removal of non-functional elements:
“commandName”: “catch”, “packageName”: “ErrorHandler”
   The fingerprint generated for the third code block would be:
asStasStasStasSt
   The fingerprint generated for the fourth code block would be:
caEr

Note, in this above example, the fingerprint for the third code block does not match the fourth code block. Hence, the third code block and the fourth code block are unique code blocks and not substantial duplicates.

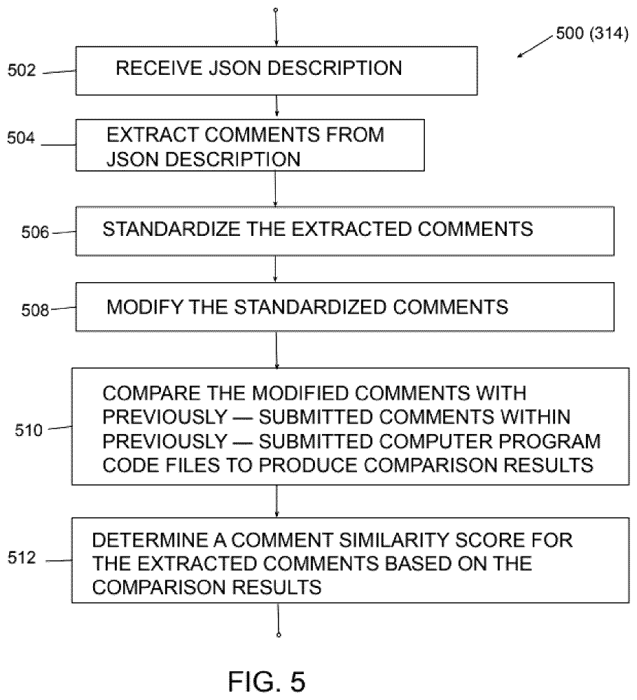

FIG. 5 is a flow diagram of a comment evaluation process 500 according to one embodiment. The comment evaluation process 500 is, for example, one embodiment that can be implemented by the additional evaluation and/or scoring of submitted program code performed 314 by the program code evaluation process 300 illustrated in FIG. 3.

The comment evaluation process 500 can receive 502 a JSON description for the submitted program code. Next, comments from the JSON description can be extracted 504. Here, the JSON description can be scanned for comments (e.g., programmer notes) contained within the JSON description of the submitted program code. The extracted comments can then be standardized 506. The standardizing 506 of the extracted comments can enhance comparison efforts. Examples of the standardization 506 that can be performed include, for example, altering formatting (e.g., capitalization) (e.g., (“cmnt” becomes “CMNT”), spacing (e.g., inter-word spaces, inter-sentence spaces), sizing (e.g., font size), etc. Next, the standardized comments can be modified 508. Examples of modifications 508 that can be imposed on the standardized components include: removal of vowels (e.g., “coment” becomes “cmnt”), removal of duplicate characters (e.g., “comment” becomes “coment”), removal of non-standard characters (e.g., retain only characters to A-Z and 0-9) (e.g., “** comment **” becomes “comment”). There modification and standardizations serve to provide some fuzzy logic type comparisons which offer the ability to ignore spelling errors and variations for words or their formatting. In some cases, standardizations can be considered modifications.

The modified comments can then be compared 510 with previously-submitted comments from previously-submitted computer program code submissions to produce comparison results. Thereafter, a comment similarity score can be determined 512 for the extracted comments based on the comparison results. The comment similarity score provides a meaningful indication of how similar the comments within the submitted program code are to comments within previously-submitted computer program code.

As noted above, comments contained within submitted computer program code can be used in evaluating computer program code submissions for uniqueness. Below is an embodiment of exemplary program code to compare comments within submitted computer program code against comments previously submitted with prior computer program code submissions. In the exemplary computer program code, comments included for assisting with understanding are denoted by “//”.

```
//receive applications to compare in JSON format
VAR node1 = REST Web Services: POST
VAR node2 = REST Web Services: POST
//set similarity variable
VAR similarity = 0
//loop through program nodes; program 1 = node1, line1; program 2 = node2,
line2
FOR EACH node1 as line1
    //check if line1 is a comment
    IF line1 DOES NOT START WITH (“//”, “/*”, “REM”, “COMMENT”) GOTO
NEXT
    //convert comment to uppercase and remove non-letter characters
    simplified_line1 = line1 => toUpperCase => keep_A-Z_only
    //replace common character pairs to simplified versions
    simplified_line1 = simplified_line1 => replaceSHwithS => replace THwithT
=> replaceSLwithS
    //remove double letters
    simplified_line1 = simplified_line1 => removeRepeatingLetters
    //loop through other program nodes
    FOR EACH node2 as line2
      //check if line2 is a comment
      IF line2 DOES NOT START WITH (“//”, “/*”, “REM”, “COMMENT”)
GOTO NEXT
      //convert comment to uppercase and remove non-letter characters
      simplified_line2 = line2 => toUpperCase => keep_A-Z_only
      //replace common character pairs to simplified versions
      simplified_line2 = simplified_line2 => replaceSHwithS =>
replaceTHwithT => replaceSLwithS
      //remove double letters
      simplified_line2 = simplified_line2 => removeRepeatingLetters
      //compare simplified lines
      VAR similarity_score = COMPARE(simplified_line1,
simplified_line2)
      //if the similarity_score is greater than the similarity, set the
similarity to that value
      IF similarity_score > similarity VAR similarity = similarity_score
    //end looping for second program
    END FOR
//end looping for first program
END FOR
//report the similarity of the comments in the two programs
REPORT SIMILARITY(similarity)
```

In one embodiment, the computer program code evaluation processing can, for example, operate in accordance with the following processing of submitted computer program code. A fifth computer program code submission is considered below as a simplified (e.g., truncated) fifth code block (denoted “Code block 5 (truncated)”). A sixth computer program code submission is considered below as a simplified (e.g., truncated) sixth code block (denoted “Code block 6 (truncated)”). Exemplary processing of submission of the fifth code block and the sixth code block are presented below.

### C. Comment Similarity Comparison Between Code Blocks 5 and 6

### 1. Code Block 5 (Truncated):

```
{
    “nodes”: [{
            “commandName”: “downloadFile”,
            “packageName”: “Browser”
          }
        ],
“attributes”: [{
            “name”: “title”,
            “value”: {
              “type”: “STRING”,
              “string”: “Download source file”
            }
          }
        ],
        “commandName”: “comment”,
        “packageName”: “Comment”
      }, {
            “commandName”: “OpenSpreadsheet”,
            “packageName”: “Excel_MS”
          }
        ],
“attributes”: [{
            “name”: “title”,
            “value”: {
              “type”: “STRING”,
              “string”: “Read Source Data”
            }
          }
        ],
        “commandName”: “comment”,
        “packageName”: “Comment”
      }
```

### 2. Code Block 5 Limited to Comments:

“string”: “Download source file”
“string”: “Read Source Data”

### 3. Standardized and Modify Comments of Code Block 5:

Next, according to one embodiment, the raw comments from the code block 5 can be standardized and/or modified. In this example, the letter characters in the raw comments can be converted to uppercase, as needed, for standardization. Also, in this example, for modifications, vowels, duplicate letters and non-letter characters can be removed from the raw comments. Following such standardizations and modifications, the resulting comments for code block 5 can become:
DWNLDSRCFL
RDSRCDT

### 4. Code Block 6 (Truncated):

```
{
    “nodes”: [{
              “commandName”: “downloadFile”,
              “packageName”: “Browser”
            }
        ],
“attributes”: [{
            “name”: “title”,
            “value”: {
              “type”: “STRING”,
              “string”: “Download file”
            }
          }
        ],
        “commandName”: “comment”,
        “packageName”: “Comment”
      }, {
            “commandName”: “OpenSpreadsheet”,
            “packageName”: “Excel_MS”
          }
        ],
“attributes”: [{
            “name”: “title”,
            “value”: {
              “type”: “STRING”,
              “string”: “Read data”
            }
          }
        ],
        “commandName”: “comment”,
        “packageName”: “Comment”
      }
```

### 5. Code Block 6 Limited to Comments:

“string”: “Download file”
“string”: “Read data”

### 6. Standardized and Modify Comments of Code Block 6:

Next, according to one embodiment, the raw comments of the code block 6 can be standardized and/or modified. In this example, the letter characters in the raw comments can be converted to uppercase, as needed, for standardization. Also, in this example, for modifications, vowels, duplicate letters and non-letter characters can be removed from the raw comments. Following such standardizations and modifications, the resulting comments for code block 6 can become:
DWNLDFL
RDDT

### 7. Compute Similarity of Resulting Comments

After processing the comments in the code blocks 5 and 6, a comment similarity percentage can be computed. For example, in one implementation, Next, according to one embodiment, the resulting comments of the code block 6 can be compared against the resulting comments of the code block 5.
Resulting code block 5 has ten (10) characters.
Resulting code block 6 has seven (7) characters.
   Here, according to one exemplary comparison, the comparison can be based on the percentage of characters that match. In this particular example, the percentage matching is seven (7) characters in the resulting code block 6 match one of the characters in the resulting code block 5. Hence, the percentage matching is 7/17 or 41%. The percentage matching is the comment similarity percentage, which can be used as a comment similarity score.

The submission of the later code block, e.g., code block 6, can then be graded based on at least the comment similarity score. Depending on predetermine thresholds for non-uniqueness, the comment evaluation processing can determine (i) whether the comments of the code block 6 are non-unique from the comments of the code clock 5 based on the comment similarity score being unacceptably too high, and/or (ii) whether the code block 6 is likely non-unique due at least in part by having an unacceptably high comment similarity score and perhaps have its submission declined.

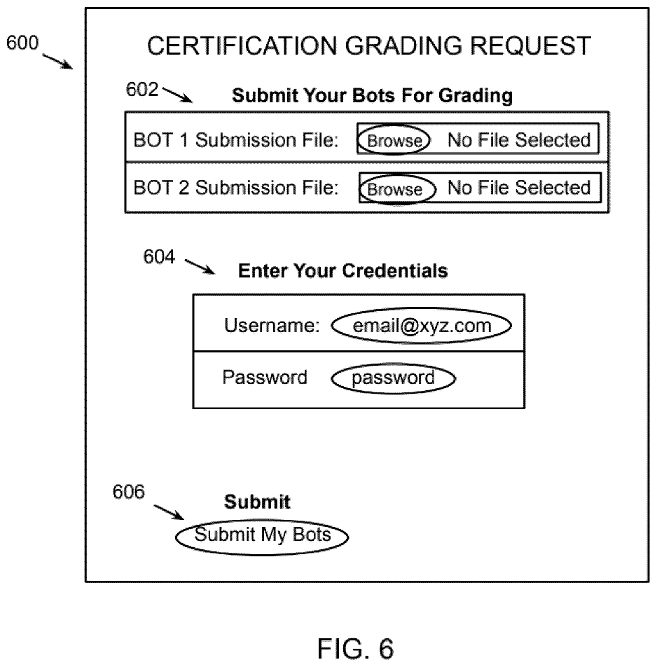

FIG. 6 is an exemplary graphical user interface 600 for requesting certification grading according to one embodiment. The graphical user interface 600 can, for example, be display on a screen of a computing device such that a user is able to view grading results from their request for certification grading. The graphical user interface 600 includes a bot identification region 602 that allows a submitter (e.g., requestor) to identify one or more electronic files for bots that are to be submitted for grading. The graphical user interface 600 can also include a requestor credentials region 604 that allows the submitter to be identified, such as by the submitter providing username and password credentials so that the system can recognize the submitter, such as via their previously established account. The graphical user interface 600 can also include a submission region 606. The submission region 606 can, for example, include a submission button to affect the submission of the one or more identified bot for certification grading.

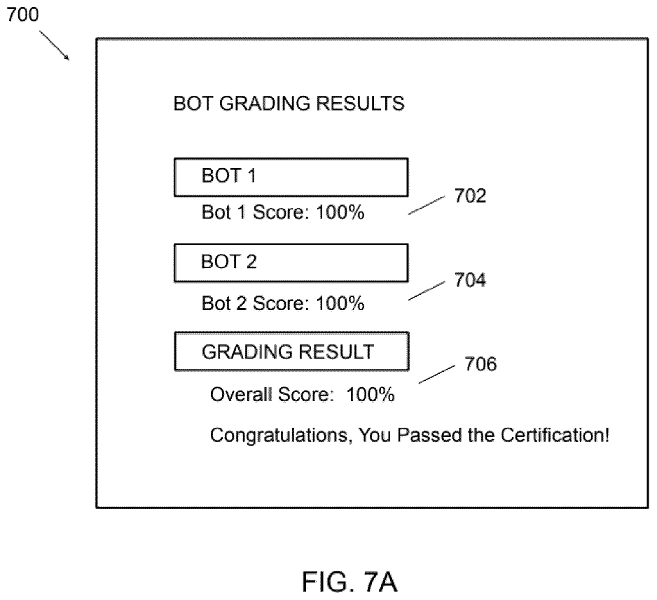

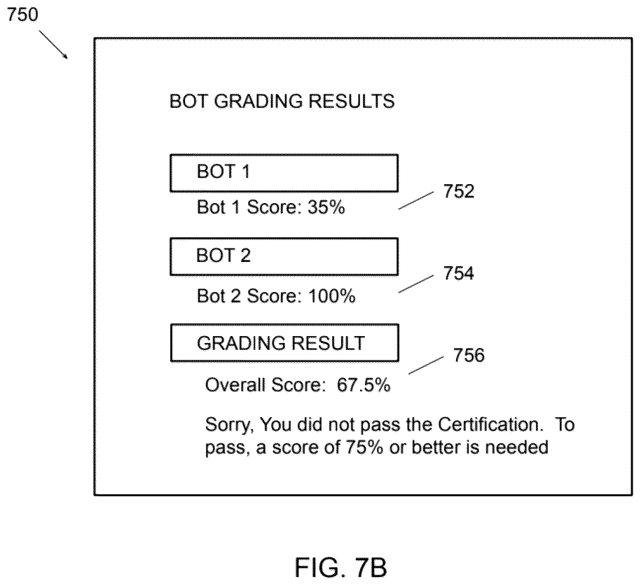

FIG. 7A is an exemplary graphical user interface 700 for presenting grading results from a first request for certification grading according to one embodiment. The graphical user interface 700 can, for example, be display on a screen of a computing device such that a user is able to view grading results from their request for certification grading. The exemplary graphical user interface 700 provides a first bot region 702 that presents a first bot (i.e., bot 1) score, which is this example was scored at 100%. The exemplary graphical user interface 700 provides a second bot region 704 that presents a second FIG. 7A is an exemplary graphical user interface 700 for presenting grading results from a first request for certification grading according to one embodiment. The graphical user interface 700 can, for example, be display on a screen of a computing device such that a user is able to view grading results from their request for certification grading. The exemplary graphical user interface 700 provides a first bot region 702 that presents a first bot (i.e., bot 1) score, which is this example was scored at 100%. The exemplary graphical user interface 700 provides a second bot region 704 that presents a second bot (i.e., bot 2) score, which is this example was scored at 100%. The exemplary graphical user interface 700 also provides grading result region 706 that presents a grade for the certification request. In this example, the requestor that submitted the first request for certification, is informed by text or graphics provided in the grading result region 706 that an overall grade obtained was 100% and that certification obtained, with an exemplary message displayed stating “Congratulations, you passed the Certification!”.

FIG. 7B is an exemplary graphical user interface 750 for presenting grading results from a second request for certification grading according to one embodiment. The graphical user interface 750 can, for example, be display on a screen of a computing device such that a user is able to view grading results from their request for certification grading. The exemplary graphical user interface 750 provides a first bot region 752 that presents a first bot (i.e., bot 1) score, which is this example was scored at 35%. The exemplary graphical user interface 750 provides a second bot region 754 that presents a second bot (i.e., bot 2) score, which is this example was scored at 100%. The exemplary graphical user interface 750 also provides grading result region 756 that presents a grade for the certification request. In this example, the requestor that submitted the first request for certification, is informed by text or graphics provided in the grading result region 756 that an overall grade obtained was 67.5% and that certification was denied, with an exemplary message displayed stating “Sorry, you did not pass the Certification. To pass, a score of 75% or better is needed.”.

The various aspects disclosed herein can be utilized with or by robotic process automation systems. Exemplary robotic process automation systems and operations thereof are detailed below.

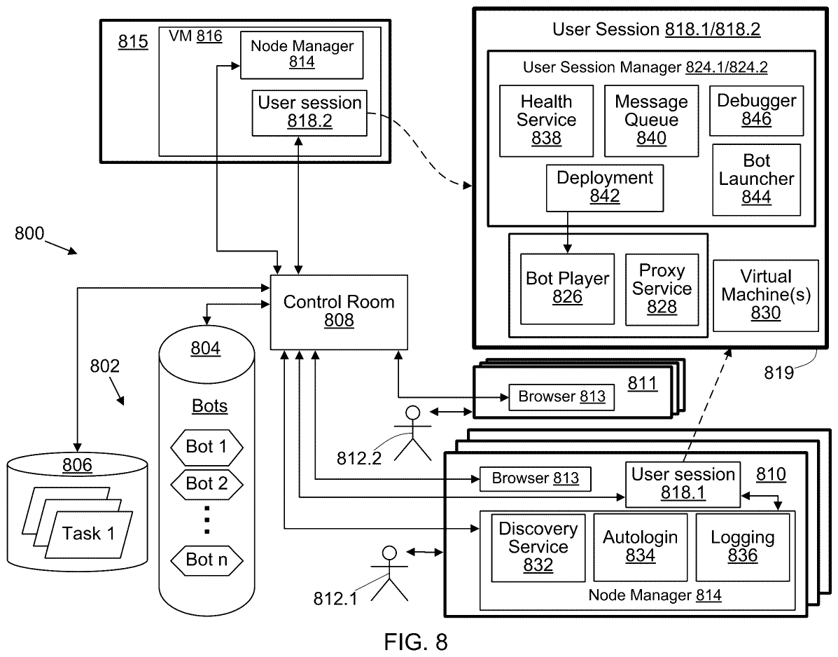

FIG. 8 is a block diagram of a robotic process automation (RPA) system 800 according to one embodiment. The RPA system 800 includes data storage 802. The data storage 802 can store a plurality of software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also store a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 can provide one or more of five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a “sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be prompted to download and install the node manager 814 on the device 810, if one is not already present. The node manager 814 can establish a web socket connection to the user session manager 824, deployed by the control room 808 that lets the user 812.1 subsequently create, edit, and deploy the bots 804.

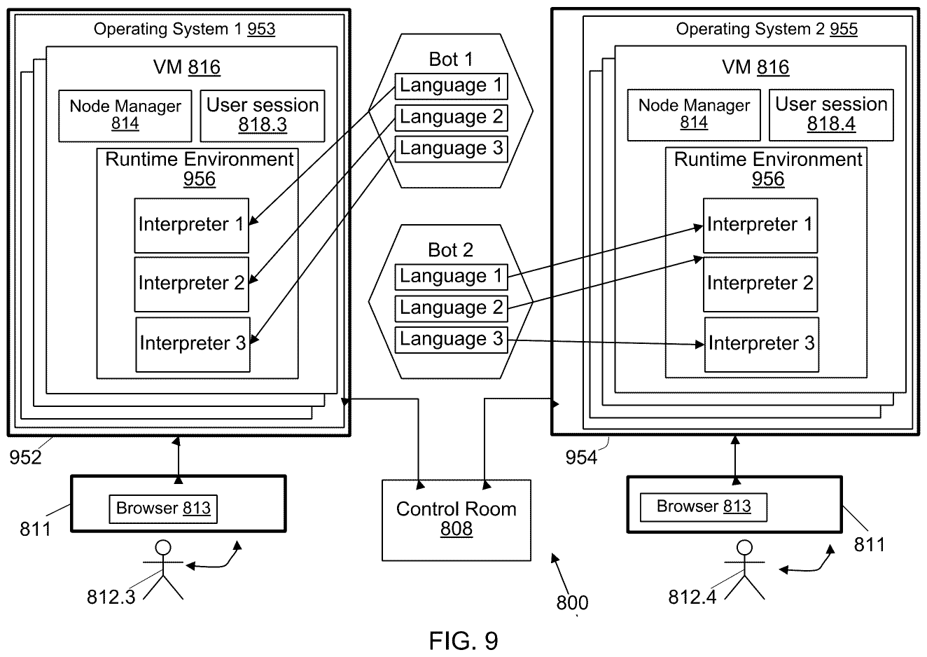

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python® programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python® and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

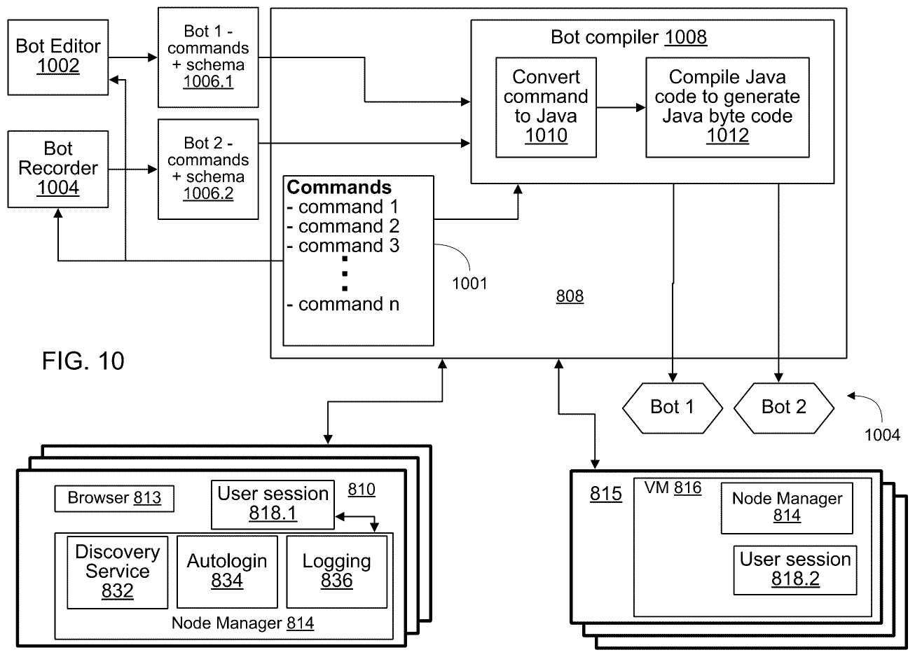

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition—December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

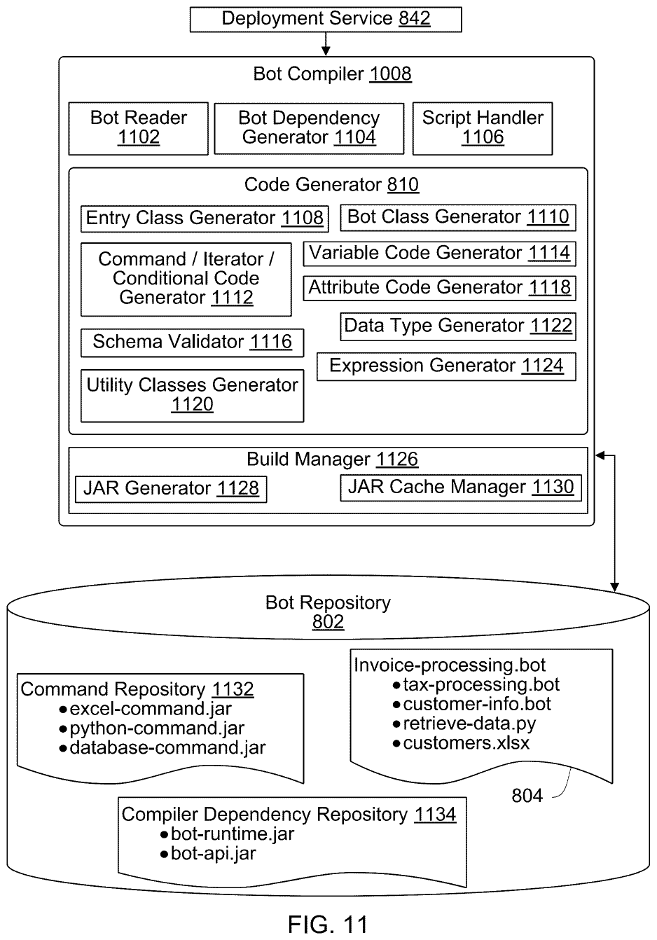

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 1008 can also access compiler dependency repository 1134. The bot compiler 1008 can operate to convert each command 1001 via code generator module 1010 to an operating system independent format, such as a Java command. The bot compiler 1008 then compiles each operating system independent format command into byte code, such as Java byte code, to create a bot JAR. The convert command to Java module 1010 is shown in further detail in in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handles the nested nature of attributes, and transforms bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in an RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

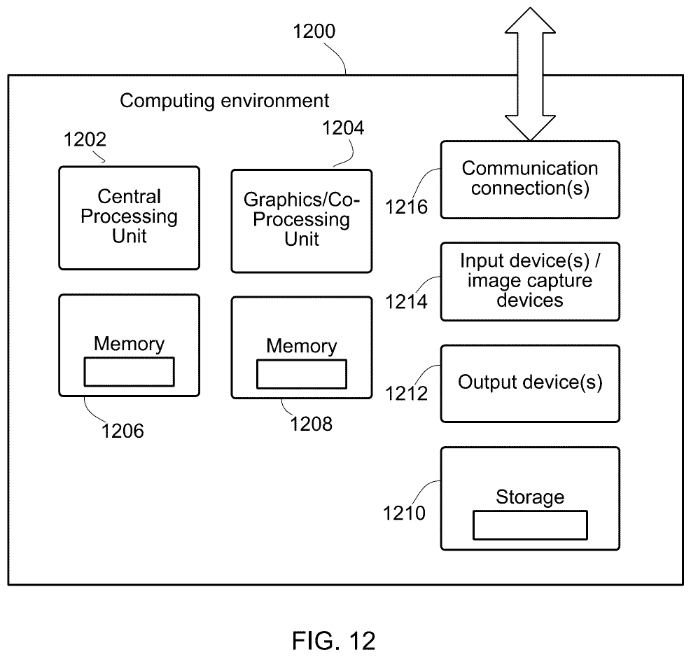

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

1. A computer-implemented method for detecting duplicate computer program code submissions, the method comprising:
receiving a program code submission, the program code submission identifying or providing a computer program code file;
generating a fingerprint for the computer program code file;
comparing the generated fingerprint with previously-submitted fingerprints for a plurality of previously-submitted computer program code files to produce comparison data;
determining whether the computer program code file is considered a duplicate computer program based on the comparison data; and
rejecting the program code submission when the determining determines that the computer program code file is considered a duplicate computer program.

2. A computer-implemented method as recited in claim 1,
wherein the previously-submitted fingerprints for the plurality of previously-submitted computer program code files are stored in a submission database, and
wherein the comparing the generated fingerprint with the previously-submitted fingerprints for the plurality of previously-submitted computer program code files to produce comparison data comprises:
accessing the database for the previously-submitted fingerprints.

3. A computer-implemented method as recited in claim 1, wherein the generating the fingerprint for the computer program file comprises:
receiving a JSON description for the computer program code file;
scanning the JSON description for a functional element; and
forming a string based on a specified characteristic of the functional element as provided in the JSON description.

4. A computer-implemented method as recited in claim 3, wherein the generating the fingerprint for the computer program file comprises:
generating the fingerprint for the computer program file based on at least the string.

5. A computer-implemented method as recited in claim 4, wherein the specified characteristic of the functional element pertains to at least a portion of a name of or associated with the functional element.

6. A computer-implemented method as recited in claim 4,
wherein the previously-submitted fingerprints for the plurality of previously-submitted computer program code files are stored in a submission database, and
wherein the comparing the generated fingerprint with the previously-submitted fingerprints for the plurality of previously-submitted computer program code files to produce comparison data comprises:
accessing the database for the previously-submitted fingerprints.

7. A computer-implemented method as recited in claim 6, wherein the specified characteristic of the functional element pertains to at least a portion of a name of or associated with the functional element.

8. A computer-implemented method as recited in claim 1, wherein the generating the fingerprint for the computer program file comprises:
receiving a JSON description for the computer program code file;
scanning the JSON description for a first functional element; and
forming a first string based on a first specified characteristic of the first functional element as provided in the JSON description;
scanning the JSON description for a second functional element; and
forming a second string based on a second specified characteristic of the second functional element as provided in the JSON description.

9. A computer-implemented method as recited in claim 8, wherein the generating the fingerprint for the computer program file comprises:
combining the first string and the second string to produce a combined string; and
generating the fingerprint for the computer program file based on at least the combined string.

10. A computer-implemented method as recited in claim 9, wherein the specified characteristic of the functional element pertains to at least a portion of a name of or associated with the functional element.

11. A computer-implemented method as recited in claim 10,
wherein the previously-submitted fingerprints for the plurality of previously-submitted computer program code files are stored in a submission database, and
wherein the comparing the generated fingerprint with the previously-submitted fingerprints for the plurality of previously-submitted computer program code files to produce comparison data comprises:
accessing the database for the previously-submitted fingerprints.

12. A computer-implemented method as recited in claim 1, comprising:
extracting comments from the computer program code file;
comparing the extracted comments with previously-submitted comments within the plurality of previously-submitted computer program code files; and
determining a comment similarity score for the extracted comments associated with the computer program code file based on the comparing.

13. A computer-implemented method as recited in claim 1, wherein the program code submission is received from a submitter, and
wherein the method comprises:
outputting a notification to the submitter of the program code submission when the program code submission is rejected.

14. A computer-implemented method as recited in claim 1, comprising:
extracting comments from the computer program code file;
standardizing the extracted comments;
comparing the standardized extracted comments with previously-submitted comments within the plurality of previously-submitted computer program code files; and
determining a comment similarity score for the standardized extracted comments associated with the computer program code file based on the comparing.

15. A computer-implemented method as recited in claim 1, comprising:
extracting comments from a JSON description for the computer program code file;
standardizing the extracted comments;
modifying the standardized extracted comments;
comparing the modified standardized extracted comments with previously-submitted comments within the plurality of previously-submitted computer program code files; and
determining a comment similarity score for the modified standardized extracted comments associated with the computer program code file based on the comparing.

16. A computer-implemented method for grading a bot suitable for use in a robotic process automation system, the method comprising:
receiving, at a bot evaluation server, a bot submission for grading, the bot submission identifying or providing a bot within a bot file;
generating a digital fingerprint for the bot;
comparing the generated digital fingerprint with previously-submitted digital fingerprints for a plurality of previously-submitted bots to the bot evaluation server, the comparing producing fingerprint comparison data;
extracting comments from the bot;
comparing the extracted comments with previously-submitted comments within the plurality of previously-submitted bots to the bot evaluation server, the comparing producing comment comparison data;
determining whether the bot is considered a duplicate bot based on the fingerprint comparison data and the comment comparison data; and
grading the bot identified or provided with the bot submission, within the grading is unfavorable when the determining determines that the bot is considered a duplicate bot.

17. A computer-implemented method as recited in claim 16, wherein the bot submission is from a bot submitter that is requesting grading of the bot identified or provided with the bot submission, and
wherein the method comprises:
declining to provide a certification to the bot submitter when the grading of the bot identified or provided with the bot submission is unfavorable, the certification indicating competency in bot creation for robotic progress automation systems.

18. A computer-implemented method as recited in claim 16, wherein the bot submission is from a bot submitter that is requesting grading of the bot identified or provided with the bot submission, and
wherein the method comprises:
blocking the bot submitter from subsequent bot submissions for a period of time when the determining determines that the bot is considered a duplicate bot.

19. A computer-implemented method as recited in claim 16,
wherein the method comprises:
extracting comments from the bot;
altering the extracted comments;
comparing the altered comments with previously-submitted alter comment within a plurality of previously-submitted bots; and
determining a comment similarity score for the altered comments associated with the bot based on the comparing, and
wherein the grading the bot identified or provided with the bot submission is at least in part dependent on a comment similarity score.

20. A computer-implemented method as recited in claim 16, wherein the bot submission is from a bot submitter that is requesting grading of the bot identified or provided with the bot submission, and
wherein the method comprises:
granting the submitter a certification indicating competency in bot creation for robotic progress automation systems when the grading of the bot identified or provided with the bot submission is favorable, the certification indicating competency in bot creation for robotic progress automation systems.

21. A bot evaluation system for grading a bot suitable for use in a robotic process automation environment, the bot evaluation system comprising:
a bot submission module configured to receive a bot submission for evaluation, the bot submission identifying or providing a bot;
a fingerprint generation module configured to generate a digital fingerprint for a plurality of bots, the plurality of bots including the bot and a plurality of previously-submitted bots;
a database configured to store at least digital fingerprints for the plurality of previously-submitted bots;
a fingerprint comparison module configured to compare the generated digital fingerprint for the bot with one or more of the digital fingerprints stored in the database for the plurality of previously-submitted bots; and
a comment similarity module configured to compare one or more comments that are included with the bot submission with previously submitted comments contained within the plurality of previously-submitted bots.

22. A bot evaluation system as recited in claim 21, wherein the bot evaluation system determines whether the bot is considered a duplicate bot based on comparison data produced by the fingerprint comparison module.

23. A bot evaluation system as recited in claim 21, wherein the bot evaluation system grades the bot identified or provided with the bot submission, with the grade being unfavorable when the bot evaluation system determines that the bot is considered a duplicate bot.

24. (canceled)
